(19) United States
(12) Patent Application Publication
(10) Pub. No.: US 2015/0229011 A1
(43) Pub. Date: Aug. 13, 2015

(54) Battery System and Motor Vehicle

(71) Applicants: Robert Bosch GmbH, Stuttgart (DE); Samsung SDI Co., Ltd., Yongin-si, Gyeonggi-do (KR)

(72) Inventor: Michael Gless, Stuttgart-Zazenhausen (DE)

(21) Appl. No.: 14/422,977

(22) PCT Filed: Jul. 18, 2013
(86) PCT No.: PCT/EP2013/065147

§ 371 Date: Feb. 20, 2015

(30) Foreign Application Priority Data
Aug. 24, 2012 (DE) 10 2012 215 056.0

(51) Int. Cl. H01M 10/6572; H02J 7/00

(52) U.S. Cl. CPC H01M 10/6572; H01M 10/613; H01M 10/615; H01M 10/625; H02J 7/0013; H01M 2200/105; H01M 2200/106

(57) ABSTRACT

A battery system includes at least one at least one battery cell, a thermoelectric element, and a thermally controllable device configured to influence a current flow. The thermoelectric element and the thermally controllable device are thermally coupled to the at least one battery cell. The thermoelectric element and the thermally controllable device are connected in series.

The present invention relates to a battery system comprising at least one battery cell, a thermoelectric element and a thermally controllable means for influencing a current flow, wherein the thermoelectric element and the thermally controllable means for influencing a current flow are thermally coupled to the battery cell. In addition, the invention relates to a motor vehicle comprising the battery system according to the invention.

### PRIOR ART

It is becoming apparent that, in the future, new battery systems which are subject to very stringent requirements in respect of reliability, safety, performance and life will be used as energy stores both in stationary applications, such as wind turbines, in motor vehicles in the form of hybrid or electric motor vehicles and in (mobile) devices, such as laptops, mobile telephones or power tools. Owing to relatively high energy densities, in particular lithium-ion batteries are used for these applications.

FIG. 1 shows how a plurality of battery cells 10 can be combined to form a battery module 12 and then a plurality of battery modules 12 can be combined to form a battery 14 (often referred to as “battery pack” or “pack” for short). Often, prior to the grouping of a plurality of battery modules 12 to form the battery 14, grouping of the battery modules 12 to form a so-called “subunit” and then grouping of a plurality of subunits to form the battery 14 takes place. These groupings take place by virtue of the pole terminals 20 of the battery cells 10 being connected in parallel or in series (not illustrated). The interconnection of the pole terminals 20 generally takes place via cell connectors (not illustrated), which can be in the form of busbars. The cell connectors are screwed or welded to the pole terminals 20 of the battery cells 10, for example. The electric voltage of a battery 14 is between 12 and 750 volts DC, for example.

Battery cells are understood to mean secondary elements, i.e. rechargeable batteries. In the literature, the terms battery cell, battery module, subunit, battery pack and battery are often also used synonymously.

In particular in the case of a cell chemistry such as that which lithium-ion battery cells have, the temperature of the battery cells influences the aging of said battery cells. If lithium-ion battery cells are heated to above temperatures of approximately 60° C., first accelerated aging can occur. At temperatures above 120° C., there is the risk of thermal runaway, i.e. an exothermic decomposition reaction of the cell.

Therefore, in accordance with the prior art, a thermal management system is used in batteries. In particular thermal management systems operating using a cooling fluid are technically complex, requiring that reliability and safety are ensured, such as, for example, that requirements in respect of density, heat transfers and regulation are met. The additional weight as a result of the cooling system and a cooling energy required for this can decrease the range.

Battery management systems and therefore also thermal management systems require an external power supply, i.e. they are only functional as an entire system. Battery cells are generally subject to temperature control using a battery cooling system. This is associated with a high level of complexity since a complete cooling system which comprises a heat exchanger, cooling plates, temperature sensing, a cooling cycle, a pump, regulation or the like is required. If a cooling system provided in the vehicle is connected instead of the heat exchanger, such as, for example, an air-conditioning system, there is the risk that the reliability and/or an ASIL (Automotive Safety Integrity Level) for this attached safety-relevant cooling function is insufficient and/or needs to be increased. Engine cooling is generally ruled out owing to excessively high temperatures as a basis for the battery cooling system.

Air-cooled systems generally require air conditioning. In addition, it is not possible to realize an impermeable or closed system.

In addition, it is apparent that the need for cooling during normal running operation is generally not required owing to high thermal capacities of the battery cells. Owing to the energy which is otherwise required for the cooling, the energy content of the battery is used more efficiently, which can result in a corresponding increase in range. In the case of relatively light vehicles, this trend generally increases.

DE 00 0004 017 475 A1 and DE 10 2008 048 002 A1 disclose battery systems in which, depending on the current flow and direction of current flow, cooling or heating takes place by means of a Peltier element. DE 00 0004 017 475 A1 discloses regulation by means of a temperature sensor, a thermostat and a polarity reversal switch. DE 10 2008 048 002 A1 describes regulation by means of a temperature sensor and a control device.

### DISCLOSURE OF THE INVENTION

The invention provides a battery system comprising at least one battery cell, a thermoelectric element and a thermally controllable means for influencing a current flow, wherein the thermoelectric element and the thermally controllable means for influencing a current flow are thermally coupled to the at least one battery cell, characterized in that the thermoelectric element and the thermally controllable means for influencing a current flow are connected in series.

The battery system according to the invention is used for temperature control of the at least one battery cell. Preferably, the thermoelectric element is a Peltier element. Temperature control, i.e. cooling or heating, of the at least one battery cell using electrical energy can take place by means of the Peltier element. Peltier elements are commonly designed for operation as thermoelectric generators. By means of the thermoelectric generator, electrical energy can be obtained from some of the waste heat from the at least one battery cell. Further preferably, the thermoelectric element can be a thermoelectric generator.

By virtue of the fact that the thermoelectric element and the thermally controllable means for influencing a current flow are connected in series, the power supply to the thermoelectric element or the flow of current out of the thermoelectric element takes place via the thermally controllable means for influencing a current flow. The temperature control therefore takes place by means of a temperature-dependent power supply to the thermoelectric element.

Typically, the thermoelectric element and/or the thermally controllable means for influencing a current flow are thermally conductively connected to the at least one battery cell, in particular to a battery cell housing of the at least one battery cell. Likewise, the thermoelectric element and/or the thermally controllable means for influencing a current flow can be thermally conductively connected to a battery module, a subunit or a battery which comprises the at least one battery cell.

In addition to chemical processes in the battery cell, physical processes can also result in heating, which can be taken into consideration depending on the positioning and connection of the thermally controllable means for influencing a current flow. Thus, the thermally controllable means for influencing a current flow can preferably also be thermally coupled to an electrical conductor of the battery system, i.e. in particular thermally conductively connected thereto. Electrical conductors can heat up owing to a flow of current and owing to their resistance. In addition, the thermally conductive means for influencing a current flow can also be thermally coupled, in particular thermally conductively connected, to a heat sink.

The regulation by means of the thermally controllable means for influencing a current flow is based on a physical relationship in accordance with which a change in the electrical resistance of said means takes place depending on its temperature. This results in a switching or regulation system which is easy to implement and which is functional purely thermoelectrically and in particular also mechanically. In addition, the regulation takes place on a level where heat is produced, in particular directly on the surface of the at least one battery cell and/or also at electrical conductors and not only on a system or pack level, for example. As a result, there is a replacement or at least a reduction and/or a substantial simplification of the temperature control system, in particular on a system plane and a substantial weight saving of the mobile system, which results in an increase in the total efficiency. The regulation takes place very quickly since there are no high thermal capacities which can make the regulation and temperature sensing more difficult and/or slower.

A safety system which is characterized by functional cooling which is already integrated on the cell or module level and which increases safety is thus now possible. As a result, there is no need for a control device (for example battery management system (BMS) or thermal management system) for ensuring temperature control of the at least one battery cell. This results in increased safety and can be used, for example, in supplementary fashion or as a replacement and/or simplification of the battery management system.

As described, cooling regulation on a cell and/or module level is possible, and monitoring is still possible on a system level in accordance with the prior art. By virtue of the invention, a thermoelectric, in particular also mechanical system is made possible, as a result of which no cooling medium such as, for example, air, water, coolant, refrigerant is required. As a result, the temperature control system, in particular the cooling system, is simplified by the use of a thermoelectric temperature control, in particular such cooling.

In addition, individual switching and/or regulation of battery cells by means of corresponding temperature control is made possible. This is expedient in particular in the case of a repair-induced, partial replacement of already aged battery cells and/or battery modules.

Furthermore, the temperature control system can be combined with already used existing safety functions such as, for example, an overcharge safety device (or OSD for short) or a battery management system (BMS).

The temperature control also functions during charging or discharging of the at least one battery cell. In addition, the battery system can be combined with temperature control, in particular cooling, which can be integrated in a stationary charging station. Thus, quick charging without overdimensioning of the temperature control device for normal running operation is possible. This results in a further weight saving of the mobile system.

Preferably, the thermally controllable means for influencing a current flow comprises a thermostat, a PTC thermistor and/or an NTC thermistor. In particular, the thermostat is a bimetallic switch. The thermally controllable means for influencing a current flow is therefore a regulation element which is in the form of a temperature-dependent conductor (in particular with an optimized characteristic) and/or a thermostat, or comprises these component parts. These component parts are typically fitted in a thermally conductive manner on the at least one battery cell or alternatively on a battery module, a subunit or a battery which comprise the at least one battery cell.

In accordance with a preferred configuration of the invention, the thermostat is connected in series with the PTC thermistor or the NTC thermistor. Owing to the series-connected thermostat, complete suppression of the current flow through the thermally controllable means for influencing a current flow above or below a predefined temperature can be achieved. At the same time, continuous regulation by means of the PTC or NTC thermistor can take place above or below the predefined temperature.

Preferably, the thermostat is connected in parallel with the PTC thermistor or the NTC thermistor. Therefore, a further increase in safety can take place by virtue of the PTC thermistor or the NTC thermistor being bypassed by the thermostat above or below a limit temperature. Therefore, for example, an NTC thermistor used for cooling can be bypassed above a predefined (critical) temperature. Therefore, current is supplied to the thermoelectric element without a voltage drop across the NTC thermistor.

Preferably, monitoring by means of the battery management system (BMS) is possible.

Preferably, the thermally controllable means for influencing a current flow and the thermoelectric element are electrically conductively connected to the pole terminals of the at least one battery cell. Therefore, the at least one battery cell and the thermoelectric element form one unit. Further preferably, the thermally controllable means for influencing a current flow and the thermoelectric element are electrically conductively connected to the pole terminals of a battery module, a subunit or a battery which comprise the at least one battery cell.

In accordance with a preferred configuration of the invention, the battery system is designed to cool and/or heat the at least one battery cell by means of the thermoelectric element. Owing to the thermoelectric effect, the temperature of the at least one battery cell is regulated depending on the current flow and the direction of current flow through the thermoelectric element. As a result, the thermoelectric effect is used for temperature regulation, in particular by means of cooling. Cooling or heating (for example in the case of cold starting) using the same thermoelectric element is possible depending on the direction of current flow. For this, further electrical or electronic component parts which are customary to a person skilled in the art can also be provided. The supply of energy for temperature control is preferably performed by the at least one battery cell or a battery module, a subunit or a battery which comprise the at least one battery cell.

Preferably, the battery system is designed to generate electrical energy from waste heat from the at least one battery cell by means of the thermoelectric element. Owing to the thermoelectric effect, current can be obtained from heat. By means of the abovementioned configuration, utilization of the thermoelectric effect for temperature regulation of the at least one battery cell is made possible. Owing to the utilization of waste heat, there is an increase in the overall efficiency, which results in an extended range of an electrically operated vehicle.

Preferably, the battery system is designed to feed electrical energy provided by the thermoelectric element into the at least one battery cell. As a result, the at least one battery cell is involved in energy recovery and storage of this energy.

In accordance with a preferred configuration of the invention, the at least one battery cell is a lithium-ion battery cell (secondary cell). Owing to the use of lithium-ion technology, in particular a high energy density is achieved, which brings with it further advantages in particular in the sector of electromobility.

In addition, a motor vehicle comprising the battery system according to the invention is provided. The battery system is generally intended for feeding an electric drive system of the motor vehicle.

Advantageous developments of the invention are specified in the dependent claims and described in the description.

### DRAWINGS

Exemplary embodiments of the invention will be explained in more detail with reference to the drawings and the description below. In the drawings:

FIG. 1 shows a battery cell, a battery module and a battery (prior art),

FIG. 2 shows configurations of thermally controllable means for influencing a current flow,

FIG. 3 shows further configurations of thermally controllable means for influencing a current flow, and

FIG. 4 shows a simplified, basic illustration of a battery system according to the invention in accordance with a preferred configuration.

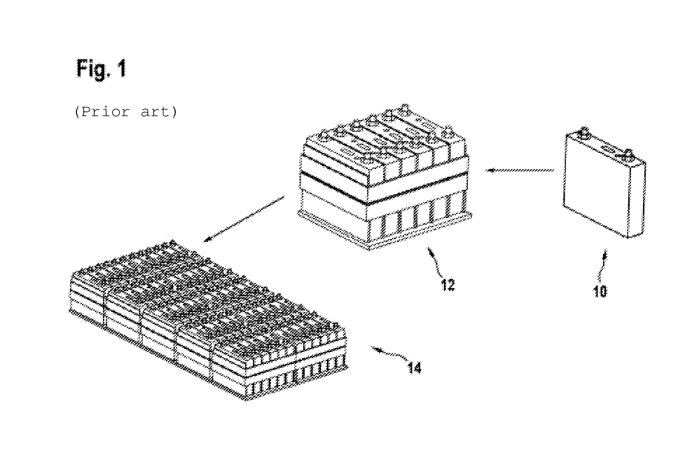

Details of FIG. 1 have already been given when explaining the prior art.

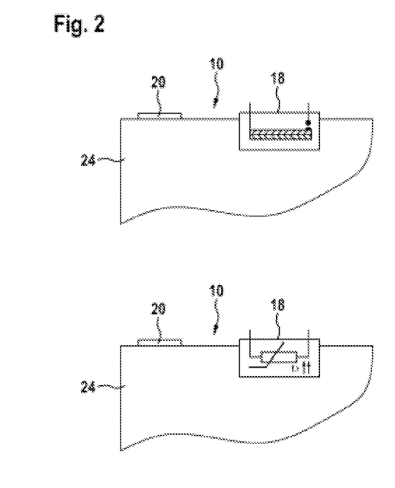

FIG. 2 shows, schematically, two variants of thermally controllable means for influencing a current flow 18. Said means are used, in conjunction with a thermoelectric element 16, for controlling and/or regulating temperature control. In each case a detail of a battery cell 10 is illustrated, said battery cell comprising a battery cell housing 24 and pole terminals 20 (cell terminals), wherein the pole terminals 20 can be electrically insulated from the battery cell housing 24 by means of an insulator 22. The thermally controllable means for influencing a current flow 18 can be thermally conductively connected to the battery cell 10, in particular to the battery cell housing 24, typically fitted thereon.

In addition, the thermally controllable means for influencing a current flow 18 can also be thermally conductively connected to a battery module 12, a subunit or a battery 14, which comprise the battery cell 10, and can generally be fitted on or within said battery cell.

In the above illustration in FIG. 2, a thermostat in the form of a bimetallic switch is illustrated. This can be designed to close or open in the event of a predefined temperature being overshot or undershot. Expedient applications are, for example, closing when a predefined temperature is overshot in order to cool the battery cell 10 or closing in the event that a predefined temperature is undershot for heating the battery cell 10.

In the illustration at the bottom in FIG. 2, the thermally controllable means for influencing a current flow 18 is depicted by means of a temperature-dependent conductor material and/or a resistance, i.e., for example, a PTC thermistor. The PTC thermistor has a resistance which increases as temperatures increase. Therefore, a higher current can be supplied to a thermoelectric element which is connected in series with the PTC thermistor at lower temperatures than at higher temperatures. Therefore, PTC thermistors are particularly expedient in embodiments for heating. The PTC thermistor therefore performs the regulation and/or control of the temperature control. Such conductor materials are expedient in particular for heating, for example in the case of cold starting.

As an alternative to this, NTC thermistors can also contribute to the implementation of the thermally controllable means for influencing a current flow 18. The NTC thermistor has a resistance which decreases with increasing temperatures. Therefore, a lower current is supplied to a thermoelectric element which is connected in series with the NTC thermistor at lower temperatures than at higher temperatures. Therefore, NTC thermistors are particularly expedient in implementations for cooling.

The temperature-dependent conductor material and/or the resistance preferably have a characteristic with a relatively high resistance (i.e. a very low resultant current flow) in the case of a desired temperature (to be reached). In addition, the characteristic should have a steep fall in resistance (resulting in a steep rise in the current flow). Above temperatures of 60° C., in particular when approaching a safety-critical temperature, the characteristic should have a relatively low resistance, which results in a relatively high current flow.

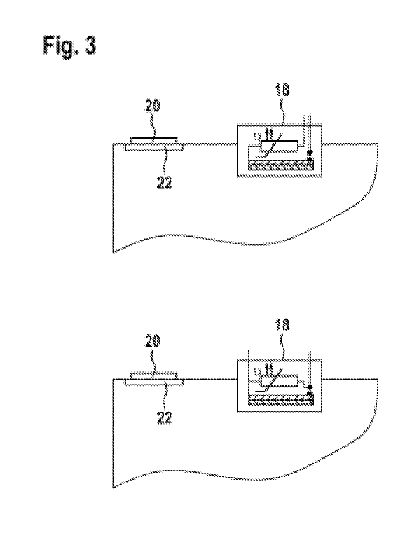

In the illustration at the top in FIG. 3, the thermally controllable means for influencing a current flow 18 is in the form of a combination of a thermostat and a PTC thermistor. The thermostat can in turn be in the form of a bimetallic switch and is connected in series with the PTC thermistor. The thermostat is in this case open at temperatures greater than a predefined temperature and closed at temperatures below the predefined temperature. Therefore, at temperatures below the predefined temperature, the same function results as in the case of the NTC thermistor described in FIG. 2, but the thermostat opens when the predefined temperature is overshot. As a result, at temperatures greater than the predefined temperature, the current flow through the thermostat is completely interrupted and not merely reduced, as in the case of the sole use of a PTC thermistor.

The thermally controllable means for influencing a current flow 18 can also be in the form of a combination of a thermostat and an NTC thermistor. The thermostat can in turn be in the form of a bimetallic switch and is connected in series with the NTC thermistor. The thermostat is in this case open at temperatures less than a predefined temperature and closed at temperatures greater than the predefined temperature. Therefore, at temperatures greater than the predefined temperature, the same function results as in the case of the NTC thermistor described in FIG. 2, but the thermostat opens when the predefined temperature is undershot. As a result, at temperatures less than the predefined temperature, the current flow through the thermostat is completely interrupted and not merely reduced, as in the case of the sole use of an NTC thermistor.

In the illustration at the bottom in FIG. 3, the thermally controllable means for influencing a current flow 18 is in the form of a further combination of a thermostat and a PTC thermistor. The thermostat can in turn be in the form of a bimetallic switch and is connected in parallel with the PTC thermistor. The thermostat is in this case open at temperatures greater than a limit temperature and closed at temperatures less than the limit temperature. Therefore, at temperatures greater than the limit temperature, the same function results as in the case of the PTC thermistor described in FIG. 2, but the thermostat closes when the limit temperature is undershot. As a result, at temperatures less than the limit temperature, the PTC thermistor is bypassed, as a result of which current can be supplied to the thermoelectric element 16 without a voltage drop across the PTC thermistor.

The thermally controllable means for influencing a current flow 18 can also be formed from a thermostat and an NTC thermistor. The thermostat can in turn be in the form of a bimetallic switch and is connected in parallel with the NTC thermistor. The thermostat is in this case open at temperatures less than a limit temperature and closed at temperatures greater than the limit temperature. Therefore, at temperatures less than the limit temperature, the same function results as in the case of the NTC thermistor described in FIG. 2, but the thermostat closes when the limit temperature is overshot. As a result, at temperatures greater than the limit temperature, the NTC thermistor is bypassed, as a result of which the current can be supplied to the thermoelectric element 16 without a voltage drop across the NTC thermistor.

In addition, combinations of the above-described parallel and series circuits are conceivable, as a result of which the advantages of said circuits can be combined.

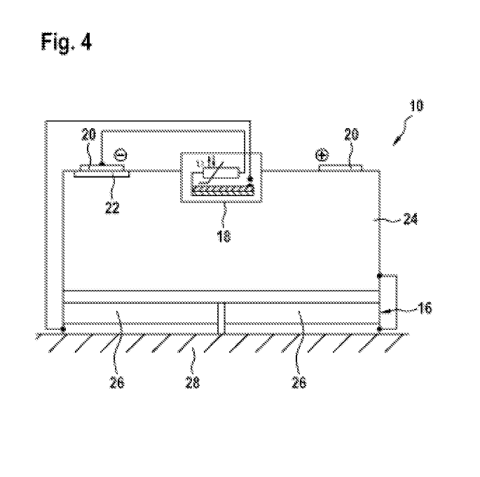

FIG. 4 shows a schematically simplified, basic illustration of a battery system according to the invention in accordance with a preferred embodiment of the invention. The battery system comprises, in addition to a battery cell 10, a thermoelectric element (for example a Peltier element) and a thermally controllable means for influencing a current flow 18, which are thermally coupled to the battery cell 10. Therefore, the thermoelectric element 16 and the thermally controllable means for influencing a current flow 18 are in thermal contact with the battery cell 10. In the configuration shown, the thermoelectric element 16 and the thermally controllable means for influencing a current flow 18 are arranged in thermally conducive fashion on a battery cell housing 24 of the battery cell 10. A solid 28 with typically very good thermal conductivity properties is arranged on that side of the thermoelectric element 16 which is remote from the battery cell 10 and is thermally conductively connected to the thermoelectric element 16. Generally, this is a heat sink or a component part with a high thermal capacity. A battery module 12, a subunit or a battery 14 (or for example also a subunit), which comprise the battery cell 10, can also be subjected to temperature control by means of an analogous design.

A thermoelectric element 16 typically comprises at least one N-doped and one P-doped semiconductor 26, which are connected in series. In the battery system shown, the thermoelectric element 16 is intended to be used for cooling, for which reason the semiconductor 26 connected to the negative pole terminal 20 of the battery cell 10 (on the left-hand side in FIG. 4) is the P-doped semiconductor. As a result, the semiconductor 26 shown on the right in FIG. 4 is the N-doped semiconductor.

The thermoelectric element 16 is connected in series with the thermally controllable means for influencing a current flow 18 and is then connected to the negative pole terminal 20. The circuit is closed by interconnection of the thermoelectric element 16 with the positive pole terminal 20. The battery cell housing of the battery cell 10 shown is electrically conductively connected to the positive pole terminal 20, but is electrically insulated from the negative pole terminal 20 by an insulator 22. Therefore, the battery cell housing 24 has the potential of the positive pole terminal 20. As a result, the thermoelectric element 16 can also be interconnected with the battery cell housing 24, instead of with the positive pole terminal 20. In the example shown, the battery cell 10 therefore performs the function of supplying energy to the temperature control. Analogously to this, a battery module 12, a subunit or a battery 14 which comprise the battery cell 10 can also perform the function of supplying energy to the temperature control.

The thermally controllable means for influencing a current flow 18 is designed analogously to that in the figure at the top in FIG. 3, but with an NTC thermistor instead of the PTC thermistor.

The battery system shown in FIG. 4 is based on the following mode of operation:

At temperatures of the battery cell 10 and therefore also of the thermally controllable means for influencing a current flow 18 of less than a predefined temperature, the thermostat is open, and therefore there is no current flowing through the thermoelectric element 16. At temperatures greater than (or else equal to) a predefined temperature, the thermostat is closed, and therefore the current flow through the thermoelectric element 16 is regulated by the NTC thermistor. As the temperature increases, the resistance value of the NTC thermistor decreases, as a result of which higher currents are supplied to the thermoelectric element 16 at higher temperatures of the battery cell 10 than at lower temperatures. If, owing to the cooling effect of the thermoelectric element 16, the temperature of the battery cell 10 and therefore also of the thermally controllable means for influencing a current flow 18 decreases, the cooling power of the thermoelectric element 16 is reduced increasingly. When the preset temperature is reached, the thermoelectric element 16 is disconnected by the thermostat.

For heating by means of the thermoelectric element 16, a PTC thermistor can be used instead of the NTC thermistor, for example. In addition, the thermostat is then designed to close only when a limit temperature is overshot. In addition, a current flow in the reverse direction through the thermoelectric element 16 is ensured by suitable means.

Likewise, current generation from the waste heat from the battery cell 10 is conceivable. For this purpose, a thermoelectric generator is used as thermoelectric element 16. Generally, Peltier elements are also suitable for operation as thermoelectric generators. The thermoelectric element, i.e. the thermoelectric generator 16, possibly also the Peltier element, can generate electrical energy from some of the waste heat from the battery cell 10.

Owing to the generally relatively poor efficiency of the thermoelectric element 16, the entire system should be optimized to a cooling power which is as low as possible. For such systems, temperature control by means of a thermoelectric element 16 is optimally suitable owing to the abovementioned advantages, however. Depending on the positioning and/or connection of the thermally controllable means for influencing a current flow 18 depending on heat transfers and heat sinks, heating owing to chemical processes in the battery cell and/or physical processes such as heating of electrical conductors owing to the current flow and resistance are taken into consideration.

1. A battery system comprising:
at least one battery cell;
a thermoelectric element; and
a thermally controllable device configured to influence a current flow,
wherein the thermoelectric element and the thermally controllable device are thermally coupled to the at least one battery cell, and
wherein the thermoelectric element and the thermally controllable device are connected in series.

2. The battery system as claimed in claim 1, wherein the thermally controllable device includes at least one of a thermostat, a PTC thermistor, and an NTC thermistor.

3. The battery system as claimed in claim 2, wherein the thermostat is connected in series with the PTC thermistor or the NTC thermistor.

4. The battery system as claimed in claim 2, wherein the thermostat is connected in parallel with the PTC thermistor or the NTC thermistor.

5. The battery system as claimed in claim 1, wherein the battery system is configured to perform at least one of cooling and heating of the at least one battery cell using the thermoelectric element.

6. The battery system as claimed in claim 1, wherein the battery system is configured to generate electrical energy from waste heat from the at least one battery cell using the thermoelectric element.

7. The battery system as claimed in claim 6, wherein the battery system is configured to feed electrical energy provided by the thermoelectric element into the at least one battery cell.

8. The battery system as claimed in claim 1, wherein the thermoelectric element is a Peltier element.

9. The battery system as claimed in claim 1, wherein the thermally controllable device and the thermoelectric element are electrically conductively connected to the pole terminals of the at least one battery cell.

10. A motor vehicle comprising:
a battery system, wherein the battery system includes:
at least one battery cell;
a thermoelectric element; and
a thermally controllable device configured to influence a current flow,
wherein the thermoelectric element and the thermally controllable device are thermally coupled to the at least one battery cell, and
wherein the thermoelectric element and the thermally controllable device are connected in series.
